(19) United States
(12) Patent Application Publication
(10) Pub. No.: US 2005/0108591 A1
(43) Pub. Date: May 19, 2005

(54) Method for reduced power consumption

(76) Inventors: Geoffrey S. Mendelson, Jerusalem (IL); Paul H. Mendelson, Jerusalem (IL)

Correspondence Address: DANIEL J SWIRSKY, PO BOX 2345, BEIT SHEMESH, 99544, IL

(21) Appl. No.: 10/705,981

(22) Filed: Nov. 13, 2003

(51) Int. Cl. G06F 1/04

(52) U.S. Cl. 713/500

(57) ABSTRACT

A method includes adjusting the clock speed of a central processing unit (CPU) as a function of the output of a performance monitor forming part of an operating system controlling the CPU. The method can be implemented on battery powered devices and on non-battery powered devices.

### FIELD OF THE INVENTION

The present invention relates to power saving devices generally.

### BACKGROUND OF THE INVENTION

Various hand-held computing devices, such as laptop computers, hand-held game machines, palmtop computers, etc., operate from battery power at least part of the time. Because battery time is limited and many computation operations can be power intensive, saving battery power is always desirable.

There are many patents on reduced power consumption. The following is a short list:
U.S. Pat. No. 6,530,027 to Morita
U.S. Pat. No. 5,745,375 to Reinhardt et al.
U.S. Pat. No. 6,519,707 to Clark et al.
U.S. Pat. No. 6,092,095 to Maytal

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of a hand-held device having a battery saving unit, constructed and operative in accordance with the present invention; and

FIG. 2 is a block diagram illustration of an alternative embodiment of the present invention, implemented on a non-battery powered device.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

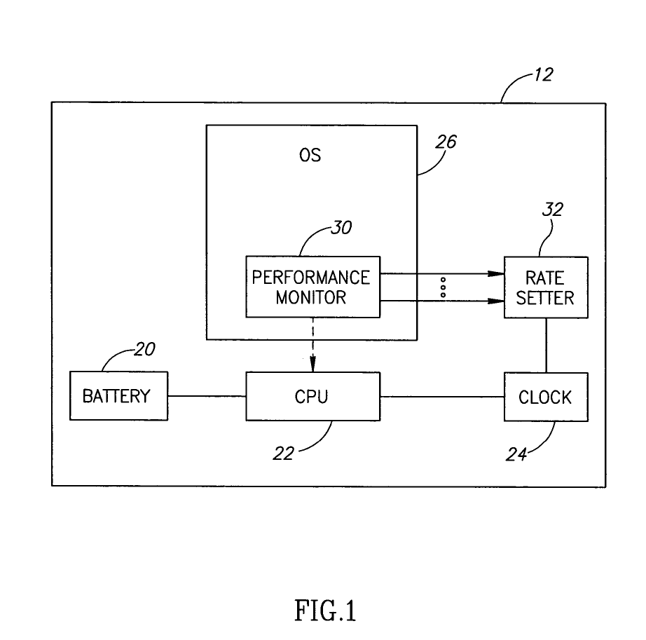

Reference is now made to FIG. 1, which illustrates a battery-powered device 12, constructed and operative in accordance with the present invention.

Battery-powered device 12 may be any movable computing device, such as a hand-held computing device, a game machine, a cell phone, a laptop computer. All such devices comprise a multiplicity of elements, among them are a battery 20, a central processing unit (CPU) 22 and at least one clock 24 controlling the operational speed of CPU 22. The device may also include an operating system 26 to operate the various hardware elements and to interface to any applications running thereon. Exemplary operating systems are the public domain Linux operating system, the Windows operating system, commercially available from Microsoft Corporation of the USA and others.

Most operating systems have performance monitors, here labeled 30, which monitor the performance of CPU 22 and other elements. Typical performance measures might be CPU utilization, input/output (I/O) activity, length of CPU queue, memory usage, I/O queue length, etc. The output of the performance monitor or monitors may be utilized by various applications in many ways, such as to determine why an instruction is taking a long time to occur.

In accordance with a preferred embodiment of the present invention, device 12 may also comprise a rate setter 32 which may adjust the speed of clock 24 as a function of one or more performance measures, such as CPU utilization, produced by performance monitor 30. In particular, when CPU 22 may be idle, the clock speed may be reduced, thereby to reduce power consumption, and when CPU 22 may become busy, the clock speed may be increased back to its original speed.

Rate setter 32 may determine the rate in many different ways. One exemplary method is as follows:
s=speed
u=utilization in % at current s
m=minimum speed ever wanted
n=max safe speed
nn=max speed possible
if u<30 then
   s=max ((0.5*s),m))
else if u<50 then
   s=max((0.5*s),m))
else if u<70 then
   s=max ((0.7*s),m))
else if u<80 then
   s=max((0.8*s),m))
if u>90 then
   s=min ((1.1*s),n))
endif

The function max(x,y) may select x or y, depending on which is larger. Similarly, min(x,y) may select the minimum of x and y.

Another exemplary function might be similar to the first one, above, but may also include the following to allow for a high burst capability:
if (u=100) and (s=max) then
   set s=nn
   wait 100 ms
   set s=n
endif

The above functions for changing the clock speed are exemplary only; the present invention incorporates all methods of changing the clock speed as a function of the output of a performance monitor.

Applicants have realized that battery powered devices, such as device 12, are not the only ones that can benefit from a reduced clock speed. There are plenty of powered devices that have computers therein but that are not continually operative. For example, a microwave oven is frequently idle. Other computerized appliances, such as a washing machine, a video cassette recorder (VCR), a DVD player, a refrigerator, an oven, etc., have computers therein but are frequently idle. A rate setter, similar to rate setter 32, may be utilized in such devices to reduce the clock speed during periods when the CPU is idle.

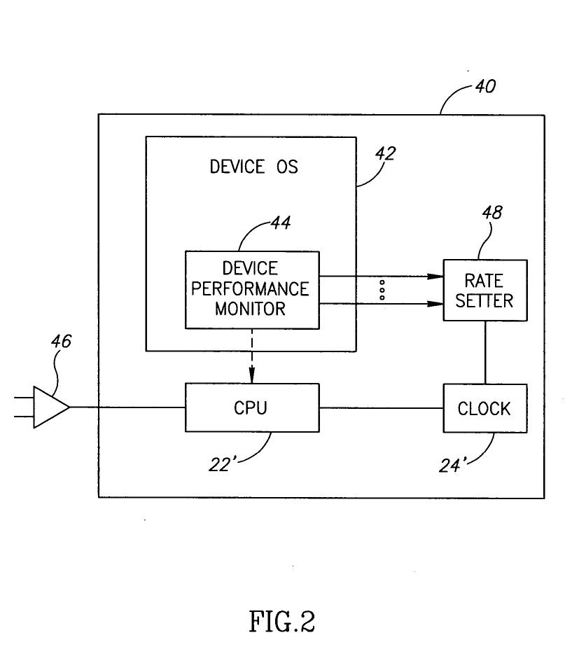

Reference is now made to FIG. 2, which illustrates such a system. The device, labeled 40, may be any computerized appliance. Such a device may have, among its elements, a device operating system 42 with its own, simplified device performance monitor 44, a lower performance CPU 22′ than in the previous embodiment, and a clock 24′. The elements of device 40 may be powered by an external power source, indicated by plug 46. In accordance with a preferred embodiment of the present invention, device 40 may also comprise a rate setter 48 which may analyze the output of device performance monitor 44 and may change the speed of clock 24′ to slow down CPU 22′ when CPU 22′ is idle and to speed up CPU 22′ when CPU 22′ becomes active.

In another embodiment, device 40 may be a DVD player which may be able to play many different types of digital recording media. For example, it may be able to play CD ROMs, DVDs and other digital media. If such a DVD player has different CPU utilization for playing the different media, its rate setter 48 may change the speed of CPU 22′ as CPU 22′ changes its utilization level (depending on the different media to be read).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method comprising:
adjusting the clock speed of a central processing unit (CPU) as a function of the output of a performance monitor forming part of an operating system controlling said CPU.

2. A method according to claim 1 and wherein said output comprises a measure of CPU utilization.

3. A method according to claim 2 and wherein said adjusting comprises lowering said clock speed by a predefined amount when said CPU utilization goes below a given utilization percentage, down to a minimum CPU speed.

4. A method according to claim 2 and wherein said adjusting comprises raising said clock speed by a predefined amount when said CPU utilization goes above a given utilization percentage, up to a maximum CPU speed.

5. A method according to claim 1 and wherein said CPU is powered by a battery.

6. A method according to claim 5 and wherein said CPU forms part of a movable computing unit.

7. A method according to claim 1 and wherein said CPU is powered by a non-battery power source.

8. A method according to claim 1 and wherein said CPU forms part of a household appliance.

9. A power saving device comprising:
a CPU;
a clock to provide timing indications to said CPU;
a performance monitor to generate measurements of said CPU's performance; and
a rate setter to change the speed of said clock as a function of at least some of the output of said performance monitor.

10. A device according to claim 9 and wherein said output comprises a measure of CPU utilization.

11. A device according to claim 10 and wherein said rate setter lowers said clock speed by a predefined amount when said CPU utilization goes below a given utilization percentage, down to a minimum CPU speed.

12. A device according to claim 10 and wherein said rate setter raises said clock speed by a predefined amount when said CPU utilization goes above a given utilization percentage, up to a maximum CPU speed.

13. A device according to claim 9 and also comprising a battery to power said CPU.

14. A device according to claim 13 and wherein said device is a movable computing device.

15. A device according to claim 9 and also comprising a plug to connect to a non-battery power source.

16. A device according to claim 9 and wherein said device is a household appliance.
